(19) United States
(12) Patent Application Publication
(10) Pub. No.: US 2015/0317682 A1
(43) Pub. Date: Nov. 5, 2015

(54) ADVERTISING BEACON FOR RETAIL ENVIRONMENTS

(71) Applicant: Tagnetics, Inc., Troy, OH (US)

(72) Inventors: Kenneth W. Kayser, Catawba, VA (US); Jonathan Hager, Salem, VA (US); Ronald E. Earley, New Carlisle, OH (US)

(73) Assignee: Tagnetics, Inc., Troy, OH (US)

(21) Appl. No.: 14/800,331

(22) Filed: Jul. 15, 2015

Related U.S. Application Data
(63) Continuation-in-part of application No. 14/152,644, filed on Jan. 10, 2014.
Application No. 14/152,644 is a continuation-in-part of application No. 14/520,900, filed on Oct. 22, 2014.
Application No. 14/520,900 is a continuation-in-part of application No. 14/520,835, filed on Oct. 22, 2014.
Application No. 14/520,835 is a continuation-in-part of application No. 14/300,689, filed on Jun. 10, 2014.
Application No. 14/300,689 is a continuation-in-part of application No. 14/262,927, filed on Apr. 28, 2014, now Pat. No. 9,022,637.
Application No. 14/262,927 is a continuation-in-part of application No. 14/217,902, filed on Mar. 18, 2014.
(60) Provisional application No. 62/024,510, filed on Jul. 15, 2014.

(51) Int. Cl. G06Q 30/02; G06Q 10/08

(52) U.S. Cl. CPC G06Q 30/0261; G06Q 30/0267; G06Q 10/087; G06Q 30/0257

(57) ABSTRACT

An advertising beacon configured to inductively couple to a power and control system which may include various retail electronic devices such as electronic shelf labels, video monitor displays, out of stock or inventory control sensors, promotional glass displays, and the like. The advertising beacon wirelessly broadcasts content, such as a web address or a programmed computer code associated with a web address, to smart devices which are able to retrieve coupons, advertisements, product information and the like from the web address. The advertising beacon operates in conjunction with other electrical devices of the power and control system to aid a customer's product selection and to aid store personnel's inventory and information management.

### CROSS-REFERENCE TO RELATED APPLICATION

This application is a Continuation-in-Part of U.S. patent application Ser. No. 14/152,644 filed Jan. 10, 2014, and a Continuation-in-Part of U.S. patent application Ser. No. 14/520,900 filed Oct. 22, 2014 and U.S. patent application Ser. No. 14/520,835 filed Oct. 22, 2014, which are each a Continuation-in-Part of U.S. patent application Ser. No. 14/300,689 filed Jun. 10, 2014, which is a Continuation-in-Part of U.S. patent application Ser. No. 14/262,927 filed Apr. 28, 2014, which is a Continuation-in-Part of U.S. patent application Ser. No. 14/217,902 filed Mar. 18, 2014. This application additionally claims priority to U.S. Provisional Patent Application Ser. No. 62/024,510 filed Jul. 15, 2014. The entirety of these applications are incorporated herein by reference.

### FIELD OF THE INVENTION

The present disclosure generally relates to systems and methods of retail advertising. More specifically, the present disclosure is directed to systems and methods of an advertising beacon providing micro-located notifications and advertisements to a customer via a smart device as the customer traverses a retail environment.

### BACKGROUND

A recent trend among retailers is the use of wireless micro-location beacons to broadcast radio signals to smart devices using Bluetooth or similar technology. The beacons are used to send push notifications, advertisements, or coupons to customers as they traverse a retail environment. A single retail store may contain a plurality of such beacons, so long as they are placed in such a manner so as not to interfere with each other. For example, in the context of a grocery store a beacon at the store entrance may notify a customer of a special promotion in the store that day, a second beacon in the produce section may provide a coupon for bananas, and so on.

Current uses of beacons face several drawbacks. First, existing beacons are battery powered and require either battery replacement or replacement of an entire beacon once the battery is dead. Battery replacement is expensive for retailers, both in the money required to replace the battery and the time employees spend maintaining a plurality of battery powered devices. Costs associated with disposal of spent batteries can also be high. Second, existing beacons are placed using an adhesive backing or mounting brackets. It is thus difficult and/or time consuming to remove and re-position a beacon, and damage may occur to the original site where the beacon was placed. Third, existing beacons lack a technology for effectively managing the many notifications and promotions a customer may encounter while traversing a retail environment. Fourth, existing beacons generally require a cumbersome manual programming upon placement in a store. Fifth, existing beacons generally require a manual updating of the content they will push to smart devices.

### SUMMARY

It is thus an object of the present disclosure to present systems and methods to overcome the deficiencies in the prior art discussed above. An advertising beacon configured to inductively couple to a power and control system which may include various retail electronic devices such as electronic shelf labels, video monitor displays, out of stock or inventory control sensors, promotional glass displays, and the like. The advertising beacon wirelessly broadcasts content, such as a web address or a programmed computer code associated with a web address, to smart devices which are able to retrieve coupons, advertisements, product information and the like from the web address. The advertising beacon operates in conjunction with other electrical devices of the power and control system to aid a customer's product selection.

In some embodiments, a retail advertising system comprises at least one advertising beacon configured to broadcast a micro-located radio signal; at least one inventory control sensor adapted to be disposed on a shelf in a retail environment and to have retail items disposed thereon; at least one electronic shelf label, configured to display at least a price of a retail item; a power and communications distribution system comprising a controller, configured to communicate with each of the at least one advertising beacon, the at least one inventory control sensor, and the at least one electronic shelf label; a power and communications distribution loop connected to the controller; wherein each of the at least one advertising beacon, the at least one inventory control sensor, and the at least one electronic shelf label are inductively coupled to the power and communications distribution loop; and wherein each of the at least one advertising beacon, the at least one inventory control sensor, and the at least one electronic shelf label are associated by the controller with a retail item of a first retail product type.

In some embodiments, a system of advertising in a retail environment, comprises a first advertising beacon adapted to be disposed in a retail environment and to broadcast a first signal at a predetermined range, wherein the first advertising beacon is inductively coupled to a power source and wherein the first signal comprises at least an address of advertising content; a wireless access point adapted to be disposed in a retail environment; the first advertising beacon and the wireless access point configured such that a smart device entering the predetermined range of the first advertising beacon receives the first signal and connects with the wireless access point to retrieve advertising content at the address.

In some embodiments, a method in a retail advertising system comprising a plurality of advertising beacons inductively coupled to a controller and disposed in a retail environment, the method comprises transmitting, from each advertising beacon of the plurality of advertising beacons to a smart device, a micro-located signal comprising a coupon; receiving, at each of the advertising beacons of the plurality of advertising beacons from the smart device, an acceptance or rejection of the coupon; sending a notification of the acceptance or rejection of the coupon from each of the advertising beacons of the plurality of advertising beacons to the controller; aggregating at the controller the notifications received from each of the advertising beacons of the plurality of advertising beacons; and outputting, from the controller to a user interface, aggregated coupon data.

In some embodiments, a method is disclosed for the use of advertising beacons to assist customers in storing and retrieving coupons and aiding customer product selection. In some embodiments, a method is disclosed allowing the regional control of content transmitted by advertising beacons (i.e. content is not controlled by the retail establishment itself). In some embodiments, a method is disclosed for installation and setup of an advertising beacon, including associating the advertising beacon with a specific product in a retail environment.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1A is a schematic diagram of a power and control system configured for a retail environment in accordance with some embodiments of the present disclosure.

FIG. 1B is a schematic diagram of a power and control system configured for a retail environment in accordance with some embodiments of the present disclosure.

FIG. 2 is a simplified schematic diagram of a retail environment configured with a plurality of advertising beacons in accordance with some embodiments of the present disclosure.

FIGS. 3A and 3B are illustrations of content received at a smart device in accordance with some embodiments of the present disclosure.

FIG. 4 is a flow chart of a method of receiving coupons at a smart device in accordance with some embodiments of the present disclosure.

FIG. 5 is a flow chart of a method of installing an advertising beacon in accordance with some embodiments of the present disclosure.

FIG. 6 is a schematic diagram of a power connector in accordance with some embodiments of the present disclosure.

FIG. 7A is a simplified block diagram of the communication paths between an advertising beacon, a smart device, and a wireless access point in accordance with some embodiments of the present disclosure.

FIG. 7B is a component diagram of a beacon transmission in accordance with some embodiments of the present disclosure.

FIG. 8 is a simplified illustration of one embodiment of the present disclosure of an advertising beacon integrated with a system of electronic shelf labels and an out-of-stock sensor in accordance with some embodiments of the present disclosure.

FIG. 9 is a simplified illustration of a system for managing associations and content in accordance with some embodiments of the present disclosure.

FIG. 10 is a simplified block diagram of a system for managing the broadcast content of advertising beacons across a plurality of retail locations in accordance with some embodiments of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present disclosure is directed to systems and methods of retail advertising. A low-power, inductively coupled system provides power and communications to an advertising beacon which broadcasts micro-located radio signals to smart devices such as smart phones, tablets, and the like. The inductively coupled systems may additionally provide power and communications to at least one electronic shelf label, shelf video display, promotional glass display, out of stock sensor, camera and/or other electronic devices.

As used herein the term micro-located or micro-location indicates that a beacon transmits a radio signal with a range of several inches to approximately 200 feet. In general, the beacon's range is adjustable to prevent or minimize interference with surrounding beacons.

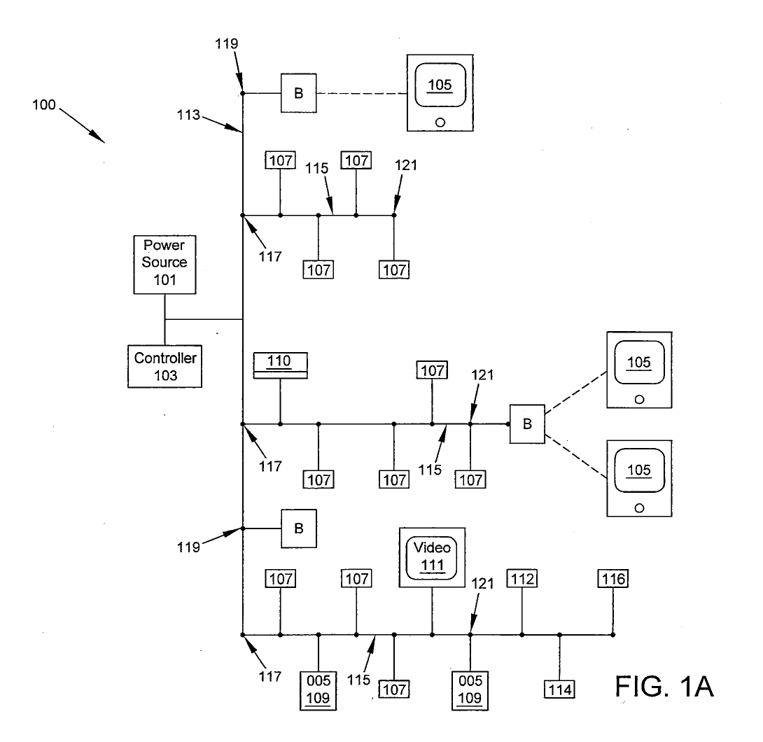

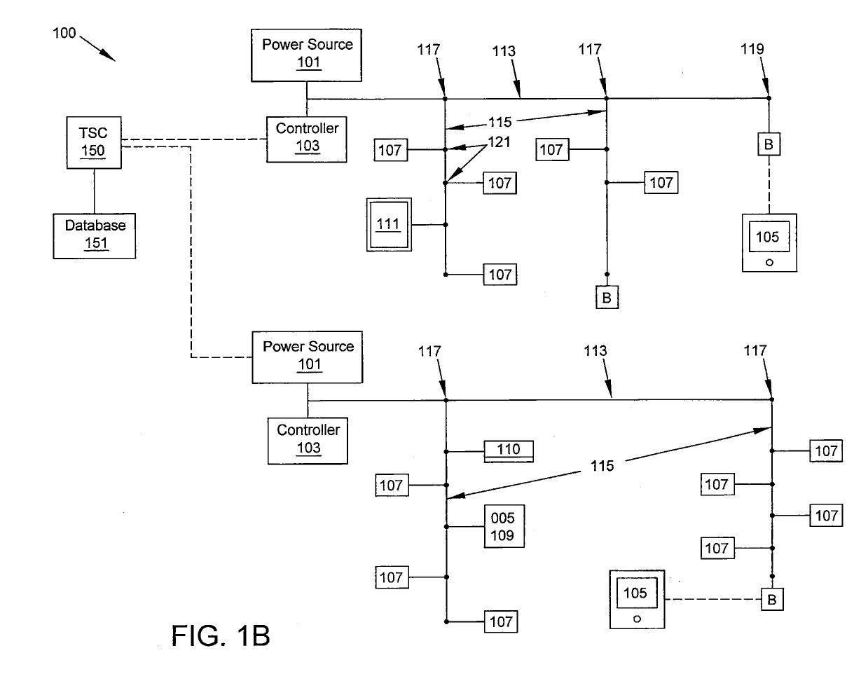

FIGS. 1A and 1B are schematic diagrams of a power and control system 100 configured for a retail environment in accordance with various embodiments of the present disclosure. In some embodiments, the power and control system 100 provides electrical power and control signals to a plurality of advertising beacons B, electronic shelf labels 107, out of stock sensors 109, promotional glass displays 110, video monitors 111, cameras 112, motion detectors 114, and/or product lighting arrays 116.

With reference to FIG. 1A, power and control system 100 comprises a power source 101 and controller 103 which provide electrical power and control signals onto a primary distribution loop 113. Secondary distribution loops 115 are connected to primary distribution loop 113 via inductively coupled connectors 117. In some embodiments, devices such as advertising beacons B, electronic shelf labels 107, out of stock sensors 109, and video monitors 111 are inductively coupled to the primary distribution loop 113 via a power converter 119. In some embodiments, a single retail environment has a plurality of primary distribution loops 113. For example, in a retail store a primary distribution loop 113 can be disposed along each row of shelves, with a secondary distribution loop 115 disposed along each shelf.

In some embodiments power source 101 is a standard wall outlet well known in the art. In other embodiments power source 101 is a battery, a solar cell, or a battery and solar cell combination. In some embodiments, controller 103 is a general purpose computer having computer program instructions for controlling the plurality of devices connected to the primary and secondary distribution loops 113, 115. In other embodiments, controller 103 is a Tag Area Controller such as used in a system of electronic shelf labels such as that disclosed in U.S. Pat. Nos. 5,537,126; 5,736,967; 6,249,263; 6,271,807; and 6,844,821.

In some embodiments, primary distribution loop 113 distributes power at between 45 and 50 VAC, 50 KHz, and 1 ampere. A frequency of 50 KHz was selected in part to comply with applicable regulatory requirements.

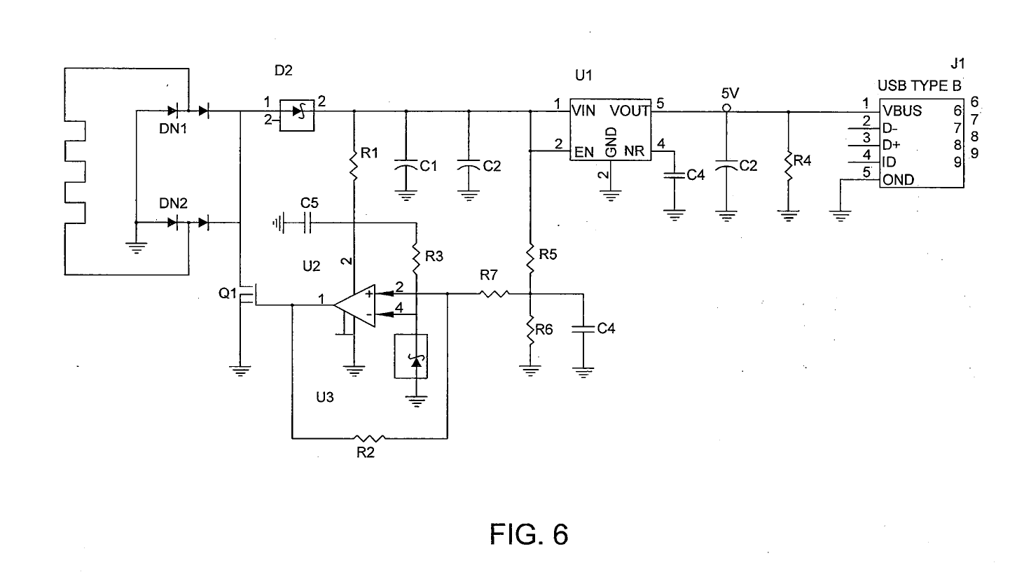

In some embodiments, connector 117 is a step-down transformer which maintains the secondary distribution loop 115 at a lower voltage, frequency, and/or amperage than primary distribution loop 113. In other embodiments, connector 117 maintains the secondary distribution loop 201 at the same voltage, frequency, and amperage as primary distribution loop 113. In still further embodiments, connector 117 is the charger illustrated in FIG. 6.

In some embodiments, power converter 119 is the device described in U.S. patent application Ser. No. 14/217,902 entitled “Power Converter.” In other embodiments, power converter 119 is the charger illustrated in FIG. 6. In still further embodiments, power converter 119 is an electrical device which converts the voltage, frequency, and amperage of primary distribution loop 201 to the voltage, frequency, and amperage required by the various electronic devices (i.e. advertising beacons B, electronic shelf labels 107, out of stock sensors 109, promotional glass displays 110, video monitors 111, cameras 112, motion detectors 114, and/or product lighting arrays 116).

Devices connected to a secondary distribution loop 115 are electrically connected using power couplers 121. In some embodiments, power coupler 121 is the device described U.S. patent application Ser. No. 14/217,902 entitled “Power Converter.”

With reference now to FIG. 1B, an embodiment is illustrated which includes a Tag Store Controller (TSC) 150 in wireless communication with a plurality of controllers 103. TSC 150 is connected to a database 151. In the embodiment of FIG. 1B, the TSC 150 is responsible for managing the overall power and control system 100, particularly the data collected by and distributed to the various electronic devices (i.e. advertising beacons B, electronic shelf labels 107, out of stock sensors 109, promotional glass displays 110, video monitors 111, cameras 112, motion detectors 114, and/or product lighting arrays 116). Controller 103 is responsible for distributing power and communications to the various electronic devices. In some embodiments, controller 103 maintains a directory of the downstream electronic devices for which it is responsible.

In some embodiments, TSC 150 provides an interface to retail store personnel which enables such personnel to control the power and control system 100. In some embodiments, TSC 150 creates notifications for retail store personnel such as an out-of-stock condition or low inventory of a retail item.

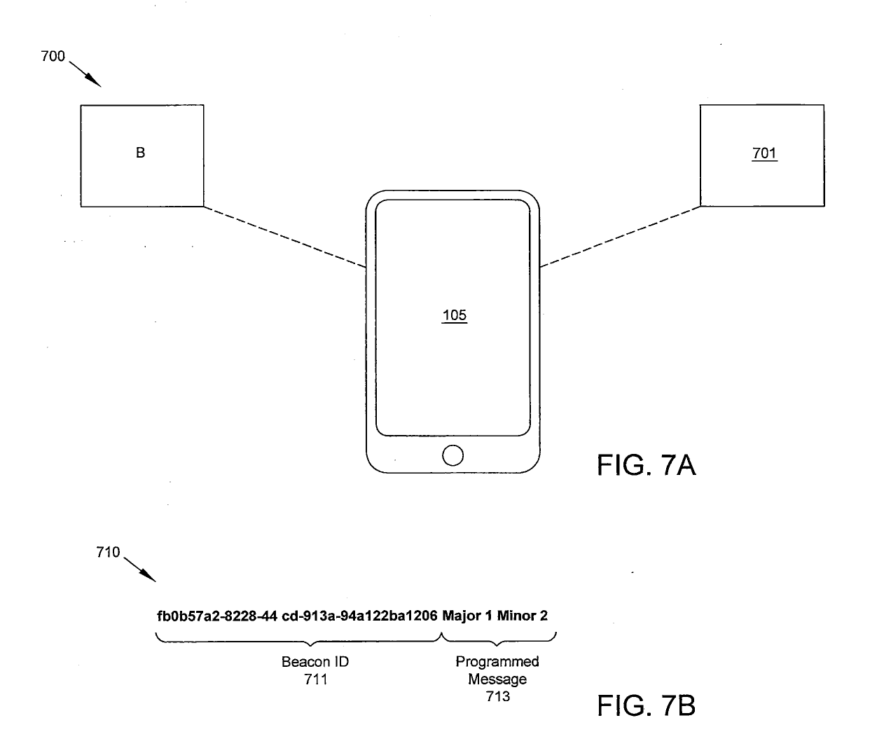

Advertising beacons B are configured to communicate wirelessly with smart devices 105, which can include smart phones, tablets, and similar devices. In some embodiments, advertising beacons B communicate wirelessly with smart devices 105 using Bluetooth technology (i.e., using short-wavelength UHF radio waves in the ISM band from 2.4 to 2.485 GHz). FIG. 7A is a simplified block diagram 700 of the communication paths between an advertising beacon B, a smart device 105, and a wireless access point 701. In some embodiments, smart device 105 receives a broadcast signal from advertising beacon B, then downloads associated content from the Internet via wireless access point 701.

In some embodiments, the advertising beacon B broadcasts a beacon transmission 710 which is formatted as shown in FIG. 7B. A beacon transmission 710 may comprise a 32-character beacon identification 711 and a programmed message 713. The programmed message 713 is able to be modified and indicates to a smart device 105 what content to download. For example, in some embodiments programmed message 713 is the address of a website containing a coupon, promotion, or advertisement, or a hyperlink to the website address. In other embodiments, programmed message 713 is a description of a location within a retail environment, and a product at that location is associated with specific content such as the address of a website containing a coupon, promotion, or advertisement for that product.

In some embodiments, programmed message 713 is advertising content such that smart device 105 is not required to connect to a wireless access point 701 to download content. In some embodiments, advertising beacon B and wireless access point 701 are co-located in the same device.

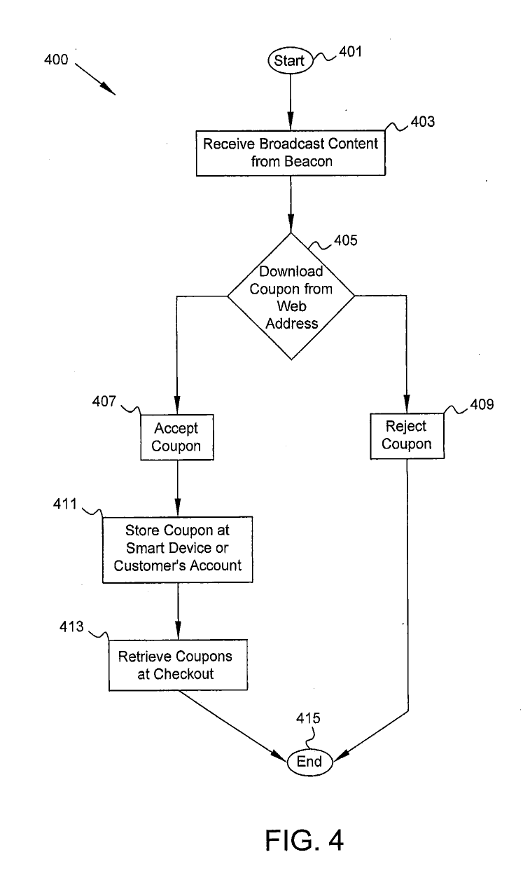

FIG. 4 is a flow chart of a method 400 of receiving coupons at a smart device 105. Method 400 starts at block 401. At block 403, a smart device 105 receives a web address as the programmed message 713 of an advertising beacon B. In some embodiments, the step of receiving a web address at a smart device 105 as transmitted from an advertising beacon B comprises receiving a code or programmed computer code which is read by the smart device 105 and translated or converted into a web address. In some embodiments, the programmed computer code includes a command for the smart device 105 to launch a web browser and download the appropriate web content.

The smart device 105 wirelessly communicates with wireless access point 701 to download the content at the associated web address, for example a coupon (block 405). A customer must then decide whether to accept or reject the coupon. If a customer accepts the coupon at block 407, the coupon is saved either to the smart device 105 or to a store rewards or similar account associated with the customer and/or smart device, or to both (block 411). Saved coupons are retrieved at checkout at block 413. The customer may also reject the coupon at block 409. The method 400 ends at block 415. After a customer (1) accepts and saves or (2) rejects each coupon at blocks 411 and 409, if the smart device 105 encounters another advertising beacon B the method 400 returns to block 403. Thus the method 400 can be performed a plurality of times during a customer's visit to a store, if the store is configured with a plurality of advertising beacons B.

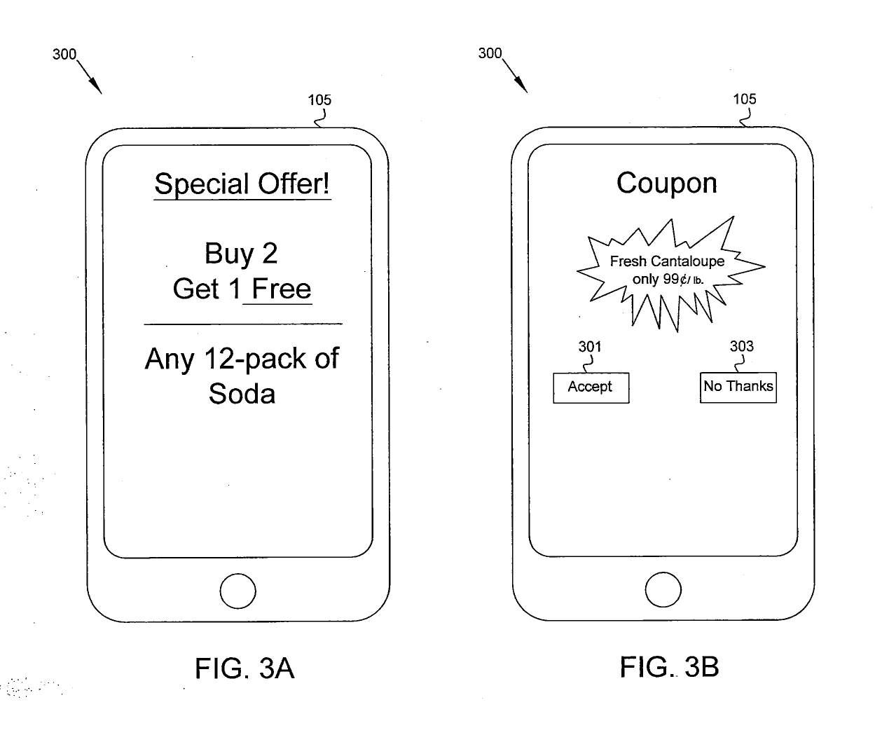

FIGS. 3A and 3B are illustrations 300 of content received at a smart device 105. A wide variety of content is envisioned for advertising beacon B to be sent to a smart device 105, including advertisements, coupons, promotions, product information, interactive planograms, and location-specific information. In some embodiments, advertising beacon B transmits a code which directs a smart device 105 to web-based content. In some embodiments, advertising beacon B transmits a reminder which is displayed as a text message, notification, or application on a smart device 105, for example a reminder once a smart device 105 enters the check-out area for the smart device 105 to retrieve all saved coupons for use. Similarly, a coupon may be saved and a price of a product adjusted at checkout based on the save coupon. In some embodiments, the coupon is saved to a customer's account with the retail establishment, such as a loyalty program or rewards account. In some embodiments, a point-of-sale is connected to a database of such accounts and can automatically retrieve stored coupons or automatically adjust product pricing based on customer interactions with advertising beacons.

As but two non-limiting examples, FIG. 3A and FIG. 3B illustrate content displayed at a smart device 105. FIG. 3A shows an advertisement for a promotion in which a store offers a sale on a specific product. FIG. 3B shows a coupon for a sale on a specific product; a customer can select the accompanying ‘accept’ region 301 or ‘reject’ region 303 to accept or reject the coupon. As discussed above with reference to FIG. 4, if a customer accepts the coupon then it can be stored in a program on the smart device 105 and retrieved at checkout or it can be stored in association with a customer's store rewards or similar account and retrieved at checkout. Similarly, the coupon may be stored in a data file and the price of a product may be adjusted based on the stored coupon at checkout.

Advertising beacons B additionally receive electrical power from the power source 101 and control signals from controller 103 via a primary and/or secondary distribution loop 113, 115. Control signals received at an advertising beacon B from controller 103 can include signals designating the power level or power range of radio broadcasting, the content of a radio broadcast, or the status of the beacon (i.e., on, off, or sleep mode).

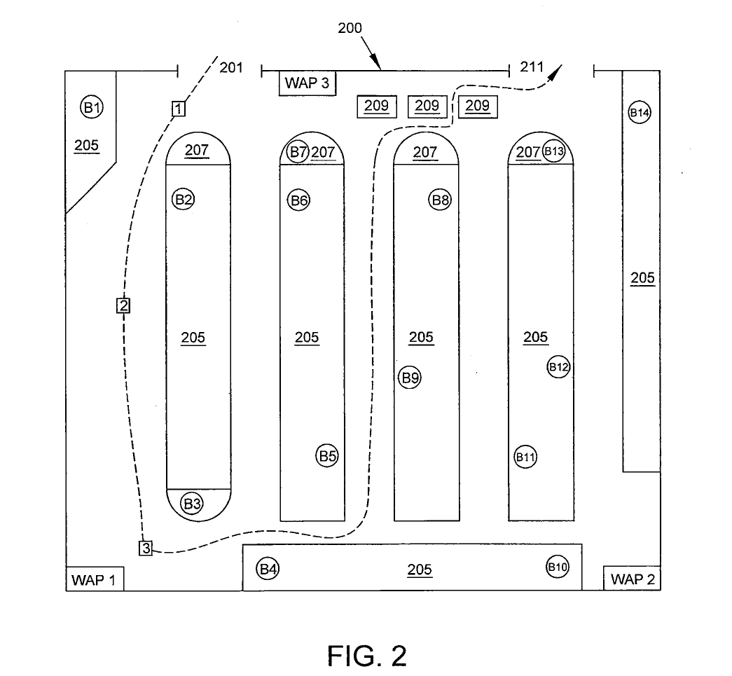

FIG. 2 is a simplified schematic diagram of a retail environment 200 configured with a plurality of advertising beacons B. The retail environment 200 resembles a typical retail store, for example a grocery store. Retail environment 200 comprises an entrance 201 and exit 211, a plurality of retail displays 205 such as shelves, refrigerated units, and the like; a plurality of retail end displays 207, and at least one check-out register 209. In some embodiments, retail environment 200 is additionally configured with at least one wireless access point, illustrated in FIG. 2 as WAP1, WAP2, and WAP3.

A plurality of advertising beacons B are disposed within the retail environment such that each advertising beacon B does not interfere with another advertising beacon B. Advertising beacons B can be associated with a product, promotion, or area of the retail environment 200. For example, in a grocery store the retail end displays 207 are frequently used to highlight certain products such as soda, potato chips, etc. An advertising beacon B placed with a retail end display 207 can be associated with a specific type or brand of soda, such that a smart device entering the range of the advertising beacon's B radio broadcast will receive a promotion for that type or brand of soda.

Additionally, in some embodiments when an advertising beacon B is placed in a retail environment 200 it is given an XY coordinate to indicate its location within the retail environment. In some embodiments, the XY coordinate is associated with an interior positioning system or Local Positioning System (LPS) for the retail environment 200. A LPS may use access points or beacons in a known position (such as position relative to an origin or predetermined XY coordinates) to determine the position of a newly-placed advertising beacon B or a smart device 105 within the retail environment 200. The position data of the advertising beacon is recorded at the controller 103.

In other embodiments, when an advertising beacon B is placed in a retail environment 200 it automatically locates its position using an integral GPS transceiver. In still further embodiments, GPS coordinates are entered manually upon installation and setup of the advertising beacon B.

Path 203 illustrates the potential movement of a customer through retail environment 200. In some embodiments, controller 103 is configured to store information regarding a smart device's 105 interaction with various advertising beacons B as the smart device 105 moves through the retail environment 200. For example, following path 203 if a smart device 105 at position 1 (indicated in FIG. 2 as a box with numeral 2 inside) interacts with a first advertising beacon B1, then moves to position 2 and interacts with a second advertising beacon B2, and finally moves to position 3 and interacts with a third advertising beacon B3, the controller 103 saves data regarding the interaction of the smart device 105 with each of the three advertising beacons B1, B2, and B3.

Using the location information (i.e., XY coordinate, LPS position, or GPS position) recorded for each advertising beacon B, controller 103 can construct a basic track of a smart device's 105 travel through the retail environment 200. Based on the number of advertising beacons B placed in the retail environment 200 and the number of advertising beacons B which a smart device 105 interacts with, the basic track could resemble path 203 which represents the actual travel of the smart device 105. With a smaller number of advertising beacons B and interactions, the basic track would appear more rudimentary. By aggregating the basic tracks of a large volume of smart devices 105 traveling through the retail environment 200, controller 103 is able to construct a traffic flow diagram or map indicating the density of smart device 105 traffic relative to the area of the retail environment 200.

In some embodiments, additional data is collected from the plurality of advertising beacons B and smart devices 105 as the smart device travels along path 203. Such data can include acceptance and rejection rates of the various offers and promotions, download rate of each coupon offered, use rate of offered or downloaded coupons, loiter time of a smart device 105 in a specific location of the store, and similar data. In some embodiments, controller 103 is configured to provide data summaries to retail store personnel, such as a ranking of the most- or least-used or downloaded coupons, the most- or least-prone areas to smart device 105 loitering, and the most- or least-accepted offers and promotions.

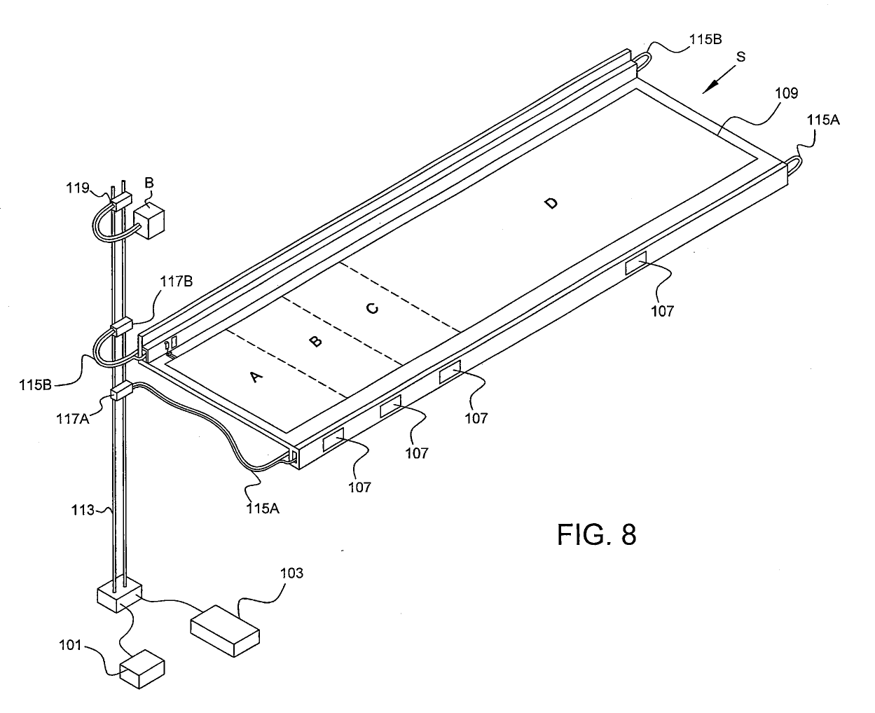

FIG. 8 is a simplified illustration of one embodiment 800 of the present disclosure of an advertising beacon B integrated with a system of electronic shelf labels 107 and an out-of-stock sensor 109. As described with respect to FIG. 1 above, FIG. 8 illustrates a power source 101 and controller 103 connected to a primary distribution loop 113.

Two secondary distribution loops 115A and 115B carry electrical power and control signals to additional devices on a retail shelf S. The first secondary distribution loop 115A is connected to the primary distribution loop 113 with connector 117A and carries electrical power and control signals to a plurality of electronic shelf labels 107 mounted to the front face of the retail shelf S. Each electronic shelf label S is inductively coupled to the first secondary distribution loop 115A by a respective power coupler 121 (not shown).

The second secondary distribution loop 115B is connected to the primary distribution loop 113 with connector 117B and carries electrical power and control signals to an out of stock sensor 109 disposed on the top surface of retail shelf S. The out of stock sensor 109 is divided into four regions (A, B, C, and D), each of which is associated with a distinct product which is placed on the out of stock sensor 109 (product not shown). Further, in some embodiments each out of stock sensor region is associated with a respective electronic shelf label 107.

FIG. 8 further illustrates an advertising beacon B connected to primary distribution loop 113 via power converter 119. In some embodiments, advertising beacon is disposed above region A of out of stock sensor 109. In some embodiments, advertising beacon is associated with the product stocked in region A and also associated with the electronic shelf label 107 disposed in front of and associated with the product stocked in region A. In some embodiments, advertising beacon B is adapted to be disposed within an electronic shelf label 107, such that the electronic shelf label 107 provides its normal functionality and additionally pushes advertising content through the use of a beacon. In other embodiments, advertising beacon B is adapted to be disposed within the frame of an electronic shelf label 107 and connected to secondary distribution loop 115.

Thus, the advertising beacon B which is integrated with the full power and control system such as pictured in FIG. 8 offers many advantages. In some embodiments an advertising beacon B which is associated with an out-of-stock sensor ceases offering a promotion or coupon once a product is out of stock. For example, the advertising beacon may be programmed to turn off or broadcast a null signal once the associated out of stock sensor 109 detects an out of stock product. In this way, customers will not receive coupons or special advertisements for a product which is no longer in stock.

In other embodiments a promotion or coupon will change based on an out of stock signal from the out-of-stock sensor. For example, a coupon associated with an out of stock retail item could be amended to offer later home delivery of the item or to provide a coupon redeemable at the customer's next visit when the retail item will presumably be in stock. Additionally, the coupon for an out of stock retail item could indicate an alternative location within a retail environment where the retail item is able to be purchased. Still further, the content transmitted from an advertising beacon B associated with an out of stock retail item could lead to the retailer's website where the product is offered for online purchasing. By way of another example, the advertising beacon B can automatically change the coupon being offered if the retail item associated with the coupon is no longer in stock so that the advertising beacon only offers coupons for retail items that are in stock.

Similarly, U.S. patent application Ser. No. 14/152,678, entitled “Inventory Control System,” discloses an inventory control system which uses weight sensors, such as the out of stock sensor 109 pictured in FIG. 8, to determine and track an inventory at the shelf Advertising beacon B can thus be programmed to cease offering a promotion or coupon once a product reaches a predetermined low inventory level.

Further, by associated an advertising beacon B with an electronic shelf label 107, the advertising beacon can aide a customer's product selection. For example, in some embodiments advertising beacon B is programmed such that once a customer has accepted a coupon offered by the advertising beacon B—as disclosed at block 407 of FIG. 4—the associated electronic shelf label 107 will flash, illuminate, or otherwise change configuration to draw the customer's attention and signal to the customer that the associated product of the coupon is stocked above the electronic shelf label 107. Similarly, U.S. patent application Ser. No. 14/262,927, entitled “Lighted Mounting Apparatus,” discloses a promotional glass display 110 which can be associated with an advertising beacon B and instructed to flash, illuminate, or otherwise change configuration to draw the customer's attention and signal to the customer that the associated product of the coupon is stocked above the promotional glass display 110. Similarly, U.S. patent application Ser. No. 14/300,689, entitled “Retail Video Monitor Display,” discloses a video monitor display 111 which can be associated with an advertising beacon B and instructed to flash, illuminate, display content, or otherwise change configuration to draw the customer's attention and signal to the customer that the associated product of the coupon is stocked above the video monitor display 111.

In some embodiments, a customer queries an advertising beacon B for additional information. For example, once a customer accepts a coupon, an additional display is provided to the customer which includes a ‘show me this product’ region and a ‘product information’ region. If a customer selects the ‘show me this product’ region, a signal is relayed through advertising beacon B to controller 103, which causes an electronic shelf label 107 or promotional glass display 110 associated with the product to flash, illuminate, or otherwise change configuration to draw the customer's attention. If the customer selects the ‘product information’ region, a signal is relayed through advertising beacon B to controller 103, which causes a video monitor display 111 associated with the product to display content providing product information. Alternatively, if the ‘product information’ region may provide a hyperlink to a webpage with product information.

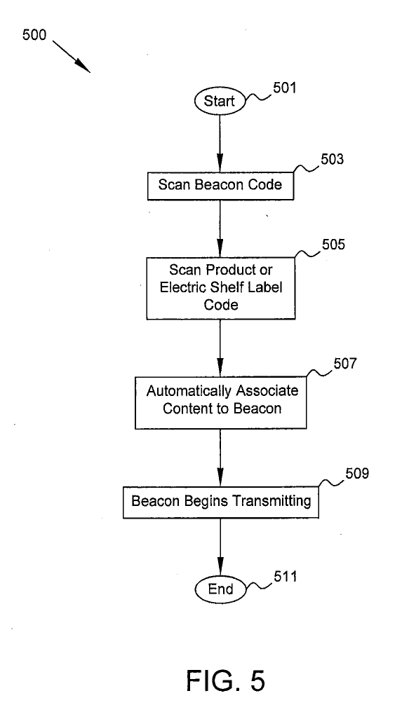

In some embodiments, the power and control system 100 provides an effective means to install an advertising beacon B. FIG. 5 is a flow chart of a method 500 of installing an advertising beacon B such that the advertising beacon B is associated with a product. The method 500 begins at block 501. At block 503, the unique identification of an advertising beacon B is provided to the controller 103. In some embodiments, this unique identification is affixed as a bar code on the advertising beacon B and provided to the controller 103 using a bar code scanner. At block 505, the unique identification of a product or electronic shelf label 107 is provided to the controller 103. As with the advertising beacon B, in some embodiments, this unique identification is affixed as a bar code on the product or electronic shelf label 107 and provided to the controller 103 using a bar code scanner. Controller 103 automatically associates the identified advertising beacon B with the identified product or electronic shelf label 107 at block 507. Once associated, the advertising beacon B begins transmitting the advertisement, coupon, promotion, or other content associated with that product (block 509). Alternatively, after the association at block 507, the advertising beacon can be manually programmed with content via controller 103. Method 500 ends at block 511. Thus the method 500 illustrated in FIG. 5 eliminates much of the manual programming to associate a beacon with a product which is required by current beacons during installation.

In still further embodiments, a system 900 is provided to control associations between various retail products and various electronic devices and components of the power and control system 100. In some embodiments, system 900 further controls the content broadcast by, displayed by, or otherwise associated with the various electronic devices. In some embodiments, system 900 is executed as software on controller 103.

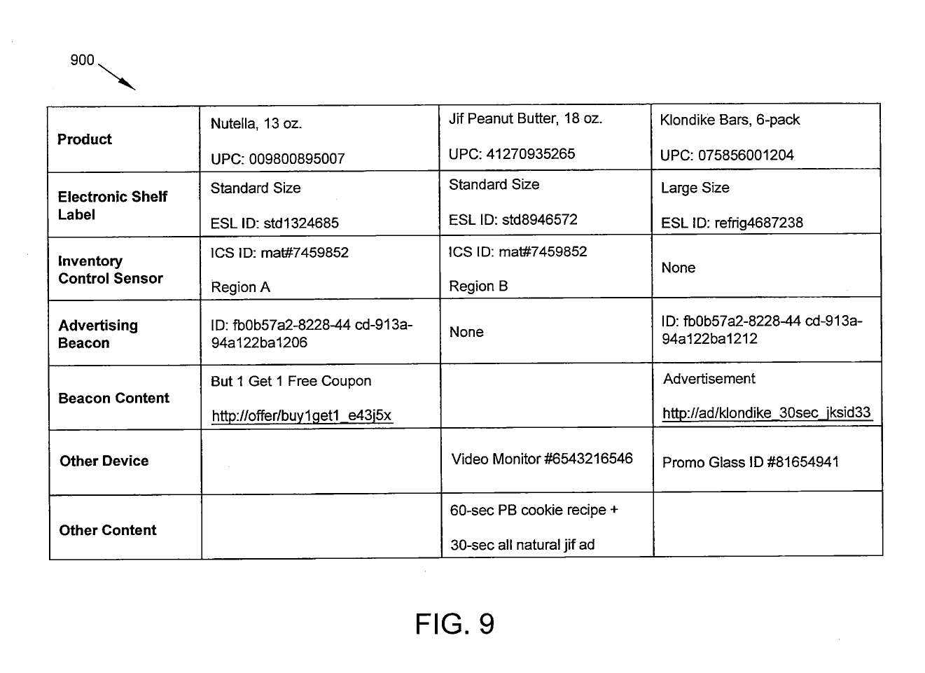

FIG. 9 is a simplified illustration of a system 900 for managing associations and content. System 900 is displayed on a display screen, for example a display screen associated with controller 103, and provides a summary of associations and content. As examples, three retail products are displayed. The display for each retail product includes a noun name (i.e., Nutella, 13 oz.) and a universal product code (UPC) which allows a user to properly identify and differentiate various products. In some embodiments, a retail product is associated with an electronic shelf label 107, and the type and identification number of the electronic shelf label 107 is displayed by system 900. In some embodiments, a retail product is associated with an inventory control sensor, sometimes referred to above as an out of stock sensor 109, and the inventory control sensor identification number (ICS ID) is displayed by system 900. For inventory control sensors with multiple sensing regions, such as that displayed in FIG. 8, system 900 additionally displays the region associated with the retail product. For example, in FIG. 9, the Nutella and Jif Peanut Butter share a common ICS ID but are located in separate regions of the sensor.

In some embodiments, a retail product is associated with an advertising beacon B. System 900 displays the identification number of the beacon and the content which the beacon is broadcasting. In the example illustrated in FIG. 9, products are associated with content located at a web address such as a coupon or advertisement. In some embodiments, a retail product is associated with further electronic devices such as a promotional glass display or a video monitor display. System 900 displays the identification numbers of these devices and any content which they will display.

System 900 enables a user to easily configure and associate content with various products. For example, a retailer or user of system 900 can input new content to be broadcast by an advertising beacon B in the form of a new web address or a new programmed computer code associated with a web address, or can change the content at the web address itself to update various promotions, sales, and the like.

In some embodiments, system 900 is software run on controller 103. Thus changes to system 900 are transmitted via power and control system 100 and received at advertising beacon B almost instantaneously. This enables a retailer to quickly and easily update the content being broadcast by various advertising beacons throughout the retail environment.

System 900 additionally makes associations between a retail product and an electronic device in the manner discussed above with reference to FIG. 5. In some embodiments, the bar code or other unique identification of a product and electronic device are sequentially scanned by a bar code reader or similar device and provided to controller 103, which automatically makes the association between the product and device in system 900. By associating the various electronic devices with a single product, controller 103 provides much of the functionality discussed above for example the ability for an electronic shelf label 107 to flash once a customer accepts a coupon transmitted by an advertising beacon B.

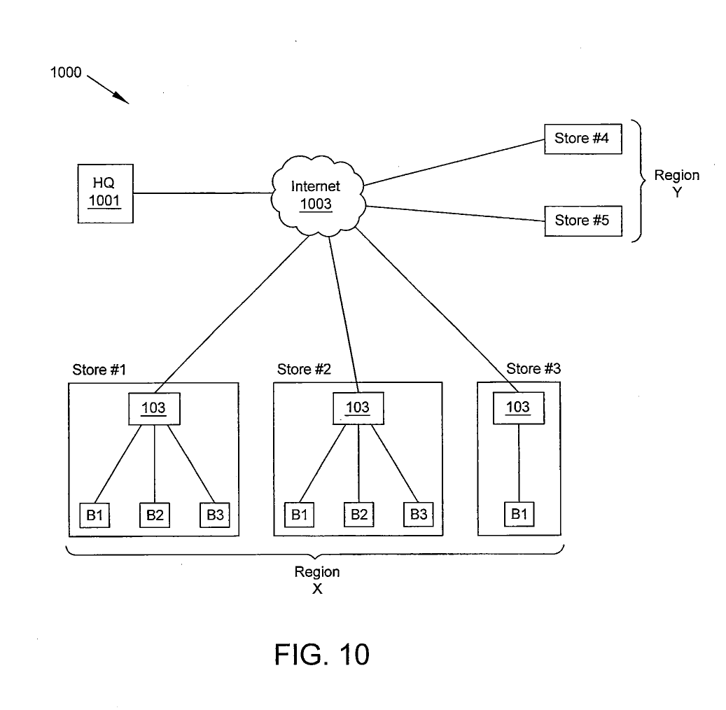

The present disclosure further provides a system 1000 for managing the broadcast content of advertising beacons B across a plurality of retail locations, as illustrated in FIG. 10. A headquarters 1001 or other content management control center is connected to the Internet 1003. A controller 103 is located in Store #1 and is also connected to the Internet 1003. Headquarters 1001 is thus able to send or ‘push’ content via the Internet 1003 out to controller 103 and then on to a specified advertising beacon. In the illustrated embodiment, a controller 103 is associated with three advertising beacons B1, B2, and B3. If each advertising beacon B1 in each store for a given retailer is associated with the same product, then the retailer's headquarters is able to push content to a full set of advertising beacons B without requiring intermediate action by store personnel. For example, if the advertising beacon B1 in Store #1, Store #2, and Store #3 are each associated with Nutella, then headquarters can issue a ‘buy 1 get 1 free’ coupon and send the required web address to each advertising beacon B1. When the promotion is completed, headquarters can either change the web address to a new coupon, advertisement, or product information associated with Nutella, or can change the content of the web address to provide a new coupon, advertisement, or product information. Further, a national retailer can group stores by regions—illustrated here as Region X and Region Y—such that promotional campaigns are consistent among like stores but can vary nationally depending on most effective marketing techniques, price variations, and the like.

In other embodiments, headquarters 1001 is able to update content of advertising beacons B across a plurality of retail locations, as illustrated in FIG. 10, by updating the web address associated with the broadcast programmed computer code of each advertising beacon. In this embodiment, content is not ‘pushed’ to advertising beacons B as described above; instead the advertising beacons continue to broadcast the same code to smart devices 105. However, the content located at the web address associated with the code is altered or updated.

In some embodiments, a retail environment is divided into sections with each section having an advertising beacon B. Sections can be assigned using a system of XY coordinates or GPS positions. The advertising beacon B in each section broadcasts a web address or programmed computer code associated with a web address which is linked to a web-based inventory control system. The web-based inventory control system receives signals from out of stock sensors and inventory control devices to track at-the-shelf inventory in real time. The web-based inventory control system is configured to display the real-time at-the-shelf inventory as a vertical planogram (i.e. a schematic of a vertical plane view of the shelf area). The vertical planogram is configurable to display data associated with each product area within the shelf section, such as product stocked in that area, current inventory, depletion rate, price, pricing change history, pending price changes, obsolete products, product facings, and electronic shelf label maintenance due or pending.

In some embodiments, the web-based inventory control system provides different access for customers and store personnel. For example, a customer may view the vertical planogram to selectably identify products of interest and to retrieve basic information regarding a product such as price, ingredients, and availability. Store personnel are able to retrieve more extensive and more detailed information, for example information regarding the pricing history of the product.

In some embodiments, shelf areas in the vertical planogram with a critical status such as out-of-stock condition, low inventory, malfunctioning equipment, or overdue maintenance appear as highlighted regions of the planogram to draw attention of store personnel to the issue. In some embodiments, the web-based inventory control system and advertising beacons B are integrated with an optical head-mounted display such as Google Glass to aid store personnel in viewing the vertical planogram as they transit the retail environment.

In some embodiments, as an advertising beacon B is installed, an installer application will associate that advertising beacon B with a section of the retail environment planogram. Depending on the density of advertising beacons B in the retail environment, the section can be an aisle, shelf, or other distinct area of the retail environment. Store personnel using smart devices 105 in the retail environment receive broadcasts from an advertising beacon B and access the planogram associated with that location or section. Store personnel can then assure planogram integrity.

It can be seen that the present disclosure provides numerous advantages over the prior art. First, advertising beacons receive electrical power via the power and control system 100, eliminating the need to expensive batteries which are difficult and time-consuming to manually replace. Second, the broadcast content of an advertising beacon can be remotely and instantaneously updated using control signals transmitted via the power and control system 100. Third, a simplified and effective method is provided for installation of the advertising beacons which allows for a rapid integration into a larger network of electronic devices and association with a specific product. Fourth, integration into the larger network provides unique functionality which aids a customer's product selection, such as the use of electronic shelf labels and promotional glass displays to indicate the location of the advertised product. Fifth, a content management system is provided which allows for remote, nationwide or region-wide alteration of advertising beacon content. Sixth, advertising beacons can be easily re-located within a retail environment and programmed messages 713 associated with the beacons can be updated to reflect the new location and new content associated with a product or products in the new location. Seventh, the advertising beacons provide crucial real-time data to retailers and in-store personnel regarding coupon utilization, advertisement success rate, and in-store traffic patterns.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, app, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network or as an app on a mobile device such as a tablet, PDA or phone.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer or mobile device. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor or other monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A retail advertising system, comprising:
at least one advertising beacon configured to broadcast a micro-located radio signal;
at least one inventory control sensor adapted to be disposed on a shelf in a retail environment and to have retail items disposed thereon;
at least one electronic shelf label, configured to display at least a price of a retail item;
a power and communications distribution system comprising:
a controller, configured to communicate with each of the at least one advertising beacon, the at least one inventory control sensor, and the at least one electronic shelf label;
a power and communications distribution loop connected to the controller;
wherein each of the at least one advertising beacon, the at least one inventory control sensor, and the at least one electronic shelf label are inductively coupled to the power and communications distribution loop; and
wherein each of the at least one advertising beacon, the at least one inventory control sensor, and the at least one electronic shelf label are associated by the controller with a retail item of a first retail product type.

2. The retail advertising system of claim 1, wherein the at least one inventory control sensor comprises more than one sensing regions, each sensing region associated at the controller with a different retail product type.

3. The retail advertising system of claim 2, wherein each of the more than one sensing region is associated at the controller with one of the at least one electronic shelf labels.

4. The retail advertising system of claim 1 wherein the controller maintains a directory of electronic devices coupled to the power and communications distribution loop.

5. The retail advertising system of claim 1 wherein the micro-located radio signal broadcast by the at least one advertising beacon consists of a beacon identification and a programmed message.

6. The retail advertising system of claim 4, wherein the programmed message comprises advertising content.

7. The retail advertising system of claim 4, wherein the programmed message comprises a hyperlink to advertising content and instructions for executing the same.

8. The retail advertising system of claim 4, wherein the micro-located radio signal broadcast by the at least one advertising beacon is configured to be received by a smart device.

9. The retail advertising system of claim 7, wherein the at least one advertising beacon is adapted to broadcast more than one micro-located radio signal.

10. A system of advertising in a retail environment, comprising:
a first advertising beacon adapted to be disposed in a retail environment and to broadcast a first signal at a predetermined range, wherein the first advertising beacon is inductively coupled to a power source and wherein the first signal comprises at least an address of advertising content;
a wireless access point adapted to be disposed in a retail environment;
said first advertising beacon and said wireless access point configured such that a smart device entering the predetermined range of the first advertising beacon receives the first signal and connects with the wireless access point to retrieve advertising content at the address.

11. The system of claim 10, further comprising a second advertising beacon adapted to be disposed in a retail environment at a distance from the first advertising beacon which ensures no interference between the first signal and a second signal broadcast from the second advertising beacon at a predetermined range.

12. The system of claim 11, wherein the second advertising beacon is inductively coupled to a power source and wherein the second signal comprises at least an address of advertising content.

13. The system of claim 12, wherein the power and communications system additionally provides power and communications to at least one of a promotional glass display, product lighting array, motion detector, video monitor, or camera.

14. The system of claim 13, further comprising a power source coupled to the power and communications distribution loop, the power source comprising at least one solar panel in combination with a battery.

15. The system of claim 11 wherein the power source inductively coupled to the first advertising beacon provides power at between 45 and 50 volts AC, 50 Khz frequency, and 1 ampere.

16. A method in a retail advertising system comprising a plurality of advertising beacons inductively coupled to a controller and disposed in a retail environment, the method comprising:
transmitting, from each advertising beacon of the plurality of advertising beacons to a smart device, a micro-located signal comprising a coupon;
receiving, at each of the advertising beacons of the plurality of advertising beacons from the smart device, an acceptance or rejection of the coupon;
sending a notification of the acceptance or rejection of the coupon from each of the advertising beacons of the plurality of advertising beacons to the controller;
aggregating at the controller the notifications received from each of the advertising beacons of the plurality of advertising beacons; and
outputting, from the controller to a user interface, aggregated coupon data.

17. The method of claim 16, wherein the aggregated coupon data comprises a ranking of coupons by acceptance rate.

18. The method of claim 16, wherein the aggregated coupon data comprises a traffic flow map of the retail environment based on the number of acceptances and rejections received at each of the advertising beacons of the plurality of advertising beacons disposed in the retail environment.

19. The method of claim 16, further comprising:
transmitting, from each advertising beacon of the plurality of advertising beacons to the smart device, instructions for storing the coupon on the smart device if the smart device accepts the coupon, wherein the stored coupon is retrieved from the smart device at checkout.

20. The method of claim 16, further comprising:
storing the coupon in a data file unique to the smart device at the controller if the smart device accepts the coupon, wherein the price of a product is adjusted at checkout based on the stored coupon.
